(19) United States
(12) Patent Application Publication
(10) Pub. No.: US 2024/0302050 A1
(43) Pub. Date: Sep. 12, 2024

(54) ADJUSTING A COOKING CYCLE ACCORDING TO THERMAL ATTRIBUTES OF COOKWARE ITEMS

(71) Applicant: Haier US Appliance Solutions, Inc., Wilmington, DE (US)

(72) Inventor: Omar Santana, Louisville, KY (US)

(21) Appl. No.: 18/119,064

(22) Filed: Mar. 8, 2023

(51) Int. Cl. F24C 7/08; F24C 15/10

(52) U.S. Cl. CPC F24C 7/083; F24C 15/105

(57) ABSTRACT

A cooking appliance includes at least one heating element; a temperature sensor configured to selectively monitor a temperature of a cookware item; and a controller operably connected with the at least one heating element and the temperature sensor, the controller configured to perform a feedback controlled heating operation. The feedback controlled heating operation includes determining a temperature setpoint; retrieving a default set of controller gain values of the feedback controlled heating operation, the set of controller gain values including a proportional gain value, an integral gain value, and a derivative gain value; directing the at least one heating element over a thermal classification length of time; determining a thermal behavior of the cookware item after an expiration of the thermal classification length of time; and adjusting one or more parameters of the feedback controlled heating operation in response to determining the thermal behavior of the cookware item.

### FIELD OF THE INVENTION

The present subject matter relates generally to cooking appliances, and more particularly to methods of operating cooking appliances according to thermal behaviors of cookware items.

### BACKGROUND OF THE INVENTION

Cooking appliances generally have one or more heating elements configured for heating a cookware item. The cookware item, e.g., a pot or a pan, may be positioned on or near the one or more heating elements and food products (including, e.g., food solids, liquid, or water) may be placed inside the cookware item for cooking. A controller may selectively energize the heating element(s) to provide thermal energy to the cookware item and the food products placed therein. Alternatively, certain cooking appliances, often referred to as induction cooktops, provide energy in the form of an alternating magnetic field which causes the cookware item to generate heat. In both types of appliances, a controller selectively energizes either the heating element(s) or a magnetic coil to heat the food products until they are properly cooked.

Cookware items may exhibit different thermal properties or behaviors. For instance, some cookware items, may have slower heat transfer rates, retain heat more easily, or dissipate heat more easily. For cooking appliances that are capable of performing feedback controlled heating operations, one or more algorithms may be used to incorporate certain feedback information (e.g., temperature change, temperature rate of change, etc.) over a heating period to intelligently control a power level of the heating element(s). However, when cookware items exhibit different properties, the single feedback control algorithm results in undesirable heating behaviors, such as excessive temperature overshoots, long heat rise times, and the like.

Accordingly, a cooking appliance and method of operating a cooking appliance that obviates one or more of the above-mentioned drawbacks would be desirable. In particular, a cooking appliance capable of adjusting one or more parameters of a heating operation would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include at least one heating element to selectively supply heat to a cookware item; a temperature sensor configured to selectively monitor a temperature of the cookware item; and a controller operably connected with the at least one heating element and the temperature sensor, the controller configured to perform a feedback controlled heating operation. The feedback controlled heating operation may include determining a temperature setpoint; retrieving a default set of controller gain values of the feedback controlled heating operation, the set of controller gain values including a proportional gain value, an integral gain value, and a derivative gain value; directing the at least one heating element over a thermal classification length of time; determining a thermal behavior of the cookware item after an expiration of the thermal classification length of time; and adjusting one or more parameters of the feedback controlled heating operation in response to determining the thermal behavior of the cookware item.

In another exemplary aspect of the present disclosure, a method of operating a cooking appliance is provided. The cooking appliance may include one or more heating elements and a temperature sensor. The method may include determining a temperature setpoint; retrieving a default set of controller gain values of the feedback controlled heating operation, the set of controller gain values including a proportional gain value, an integral gain value, and a derivative gain value; directing the at least one heating element over a thermal classification length of time; determining a thermal behavior of the cookware item after an expiration of the thermal classification length of time; and adjusting one or more parameters of the feedback controlled heating operation in response to determining the thermal behavior of the cookware item.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven range according to exemplary embodiments of the present disclosure.

FIG. 2 provides a side cut-away view of the exemplary oven range of FIG. 1.

FIG. 3 provides a graph illustrating a temperature change of various cookware items over a length of time.

FIG. 4 provides a graph illustrating an accumulation of an integral term according to a temperature change of various cookware items over a length of time.

FIG. 5 provides a flow chart illustrating a method of operating a cooking appliance according to an exemplary embodiment.

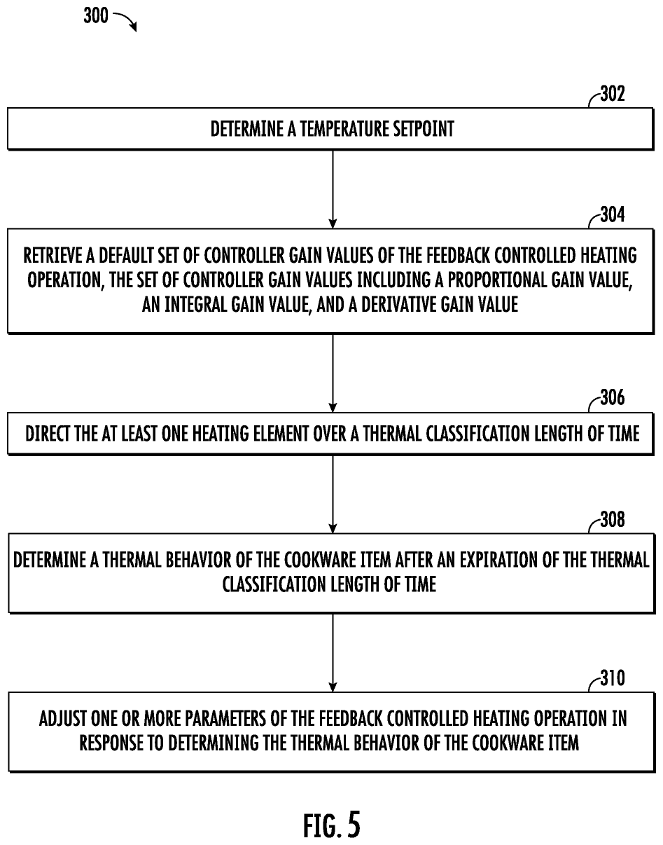

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

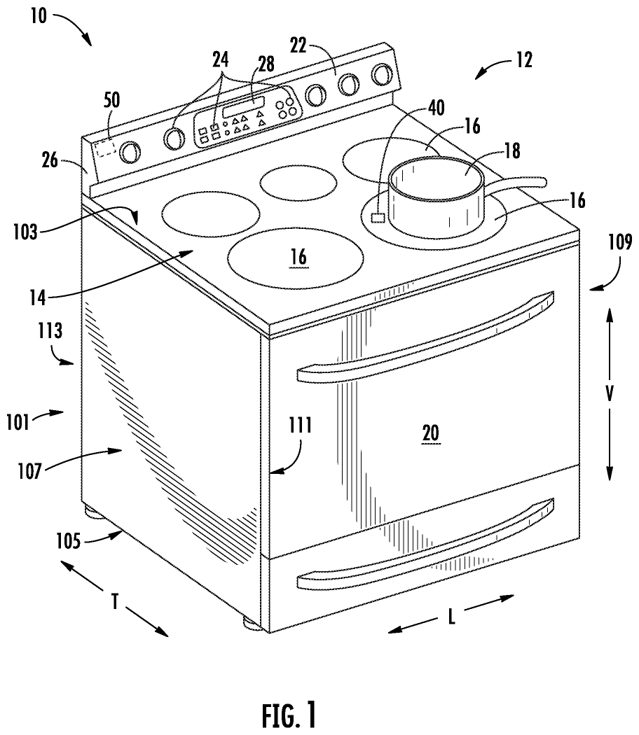

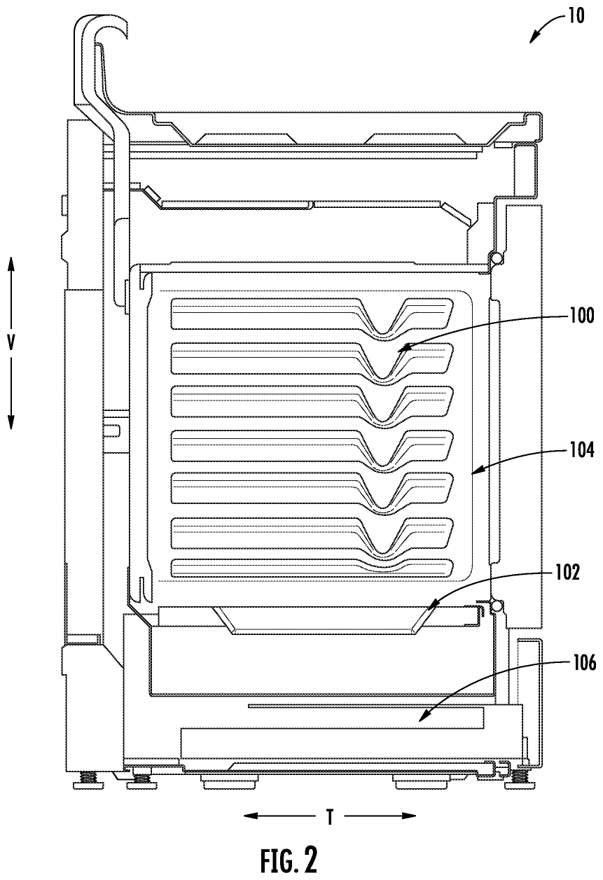

FIG. 1 provides a perspective view of a cooking appliance, or oven range 10, including a cooktop 12, and FIG. 2 provides a side cut-away view of the cooking appliance 10. Cooking appliance 10 is provided by way of example only and is not intended to limit the present subject matter to the arrangement shown in FIGS. 1 and 2. Thus, the present subject matter may be used with other range 10 and/or cooktop 12 configurations, e.g., double oven range appliances. As illustrated, cooking appliance 10 generally defines a vertical direction V, a lateral direction L, and a transverse direction T, each of which is mutually perpendicular, such that an orthogonal coordinate system is generally defined. Cooking appliance 10 may include a cabinet 101 that extends between a top 103 and a bottom 105 along the vertical direction V, between a left side 107 and a right side 109 along the lateral direction, and between a front 111 and a rear 113 along the transverse direction T.

A cooking surface 14 of cooktop 12 may include a plurality of heating elements 16. For the embodiment depicted, cooktop 12 includes five heating elements 16 spaced along cooking surface 14. Heating elements 16 may be electric heating elements and are positioned at, e.g., on or proximate to, the cooking surface 14. In certain exemplary embodiments, cooktop 12 is a radiant cooktop with resistive heating elements or coils mounted below cooking surface 14. However, in other embodiments, the cooktop appliance 12 includes other suitable shape, configuration, and/or number of heating elements 16, for example, cooktop 12 may be an open coil cooktop with heating elements 16 positioned on or above surface 14. Additionally or alternatively, in other embodiments, cooktop 12 may include any other suitable type of heating element 16, such as an induction heating element. Each of the heating elements 16 may be the same type of heating element 16, or cooktop 12 may include a combination of different types of heating elements 16.

As shown in FIG. 1, a cooking utensil (or cookware item) 18, such as a pot, pan, or the like, may be placed on a heating element 16 to heat the cookware item 18 and cook or heat food items placed within cookware item 18. Cooking appliance 10 may also include a door 20 that permits access to a cooking chamber 104 of oven range 10, e.g., for cooking or baking of food items therein. A control panel 22 having controls 24 may permit a user to make selections for cooking of food items. Although shown on a backsplash or back panel 26 of oven range 10, control panel 22 may be positioned in any suitable location.

Controls 24 may include buttons, knobs, and the like, as well as combinations thereof, and/or controls 24 may be implemented on a remote user interface device such as a smartphone. As an example, a user may manipulate one or more controls 24 to select a temperature and/or a heat or power output for each heating element 16 and the cooking chamber 104. The selected temperature or heat output of heating element 16 affects the heat transferred to cookware item 18 placed on heating element 16. A display 28 may be provided (e.g., on or in control panel 22). Display 28 may display information regarding cooking operations or inputs from a user regarding the cooking operation. Display 28 may be any suitable display capable of providing visual feedback, such as a liquid crystal display (LCD), a light emitting diode (LED) display, a segmented display, or the like. Additionally or alternatively, display 28 may be a touch display capable of receiving touch inputs from a user.

Cooktop appliance 12 may further include or be in operative communication with a processing device or a controller 50 that may be generally configured to facilitate appliance operation. In this regard, control panel 22, controls 24, and display 28 may be in communication with controller 50 such that controller 50 may receive control inputs from controls 24, may display information using display 28, and may otherwise regulate operation of cooking appliance 10. For example, signals generated by controller 50 may operate cooking appliance 10, including any or all system components, subsystems, or interconnected devices, in response to the position of controls 24 and other control commands. Control panel 22 and other components of appliance 10 may be in communication with controller 50 via, for example, one or more signal lines or shared communication busses. In this manner, Input/Output (“I/O”) signals may be routed between controller 50 and various operational components of appliance 10.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 50 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 50 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware.

Additionally, or alternatively, the instructions can be executed logically and/or virtually using separate threads on one or more processors.

For example, controller 50 may be operable to execute programming instructions or micro-control code associated with an operating cycle of cooking appliance 10. In this regard, the instructions may be software or any set of instructions that when executed by the processing device, cause the processing device to perform operations, such as running one or more software applications, displaying a user interface, receiving user input, processing user input, etc. Moreover, it should be noted that controller 50 as disclosed herein is capable of and may be operable to perform any methods, method steps, or portions of methods as disclosed herein. For example, in some embodiments, methods disclosed herein may be embodied in programming instructions stored in the memory and executed by controller 50.

The memory devices may also store data that can be retrieved, manipulated, created, or stored by the one or more processors or portions of controller 50. The data can include, for instance, data to facilitate performance of methods described herein. The data can be stored locally (e.g., on controller 50) in one or more databases and/or may be split up so that the data is stored in multiple locations. In addition, or alternatively, the one or more database(s) can be connected to controller 50 through any suitable network(s), such as through a high bandwidth local area network (LAN) or wide area network (WAN). In this regard, for example, controller 50 may further include a communication module or interface that may be used to communicate with one or more other component(s) of appliance 10, controller 50, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Cooking appliance 10 may include a temperature sensor 40. Temperature sensor 40 may be configured to selectively sense a temperature of a cookware item (e.g., cookware item 18) as it is heated. For instance, temperature sensor 40 may be integrally formed with cooking appliance 10 (e.g., within cooktop 12, within cooking chamber 104, etc.). In some embodiments, temperature sensor 40 is operably connected to cooking appliance 10 (e.g., via a port or socket, via a remote connection, etc.). For one example, temperature sensor 40 is provided within cookware item 18 and operably connected to controller 50 during a cooking operation. Temperature sensor 40 may monitor a temperature of cookware item 18 or a food item provided within cookware item 18. Accordingly, temperature sensor 40 may deliver signals (e.g., voltage signals) representing the temperature of cookware item 18 to controller 50. The signals may be sent according to a predetermined frequency (e.g., at predetermined time intervals). Thus, controller 50 may analyze a temperature or temperature change of cookware item 18.

As used herein, “temperature sensor” or the equivalent is intended to refer to any suitable type of temperature measuring system or device positioned at any suitable location for measuring the desired temperature. Thus, for example, temperature sensor 40 may be any suitable type of temperature sensor, such as a thermistor, a thermocouple, a resistance temperature detector, a semiconductor-based integrated circuit temperature sensor, etc. In addition, temperature sensor 40 may be positioned at any suitable location and may output a signal, such as a voltage, to a controller that is proportional to or indicative of the temperature being measured. Although exemplary positioning of temperature sensors is described herein, it should be appreciated that appliance 10 may include any other suitable number, type, and position of temperature or other sensors according to alternative embodiments.

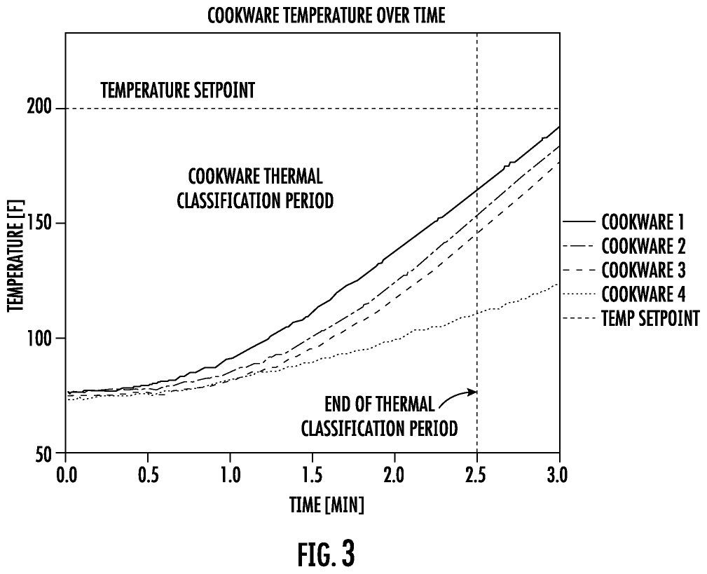

Referring now to FIG. 3, a graph illustrating temperature changes of different types of cookware over a predetermined period of time is shown. As mentioned above, temperature sensor 40 may monitor the temperature of cookware item 18 over the course of the cooking operation. The cooking operation may include a cookware thermal classification period (CTCP). During the CTCP, a thermal behavior of cookware item 18 may be determined (e.g., within controller 50). The CTCP may be predetermined within appliance 10 (e.g., during programming or manufacturing) according to empirical testing. For instance, the CTCP may be defined between an initiation of the cooking operation to between about 2 minutes and about 4 minutes. According to some embodiments, the CTCP is between about 1 minute (e.g., 1 minute after the cooking operation is initiated) to about 3 minutes (e.g., after the cooking operation is initiated). Accordingly, the CTCP may be between about 2 minutes and about 4 minutes in total length. During the CTCP, temperature sensor 40 may continually send temperature signals to controller 50.

The cooking operation may be a feedback controlled heating operation. In detail, the cooking operation may intelligently adjust one or more parameters according to feedback with respect to cookware item 18, a food being cooked, cooking appliance 100, or the like. Temperature sensor 40 may continually send temperature signals to controller 50 which may then determine, for instance, an error value associated with the feedback controlled heating operation. The error value may be a difference between a temperature setpoint and an actual observed temperature (e.g., via temperature sensor 40). The error value may be substituted into a feedback equation to determine an adjustment to be made to a control variable. For instance, the control variable may be a power level of heating element 16.

According to at least some embodiments, controller 50 includes a closed-loop feedback control algorithm. The closed-loop feedback control algorithm may be a proportional-integral-derivative (PID) algorithm or equation (e.g., equation or set of equations). In some embodiments, the algorithm may include a proportional algorithm, a proportional-integral algorithm, a proportional-derivative algorithm, or any suitable combination of terms. The PID controller may determine a proportional term (P), an integral term (I), and a derivative term (D). According to at least one embodiment, the PID algorithm is:

$$CV = P + I + D$$

where CV is a controlled variable (e.g., power input to heating element 16), P is the proportional term, I is the integral term, and D is the derivative term. As can be seen, adding each of the P, I, and D terms generates a value for the power level of heating element 16. Each of the P, I, and D terms may be found as follows:

$$P = {K}_{p} * e \\ I = {I}_{prev} + {K}_{i} * e * {T}_{s} \\ D = {K}_{d} * ( e - {e}_{prev} ) / {T}_{s}$$

where Kₚ is a proportional gain value, Kᵢ is an integral gain value, K_{d} is a derivative gain value, e is an error value (e.g., a difference between a temperature setpoint and an observed temperature), Tₛ is a sampling time or sampling time rate (e.g., a rate at which a discrete system samples inputs), Iₚᵣₑᵥ is a previous integral term (e.g., at the previous sampling time), and eₚᵣₑᵥ is a previous error value (e.g., at the previous sampling time). As noted above, however, in some instances any suitable combination of P, I, and D terms may be incorporated into the algorithm.

Further, it should be noted that the I term is accumulated over a predetermined length of time. In detail, because each iteration of the I term incorporates the previous I term (e.g., Iₚᵣₑᵥ), a total I term over the predetermined length of time is calculated. Each I term (e.g., instantaneous or current I term) is added to the previous I term, generating a complete integral term for the predetermined length of time. For one example, the I term is accumulated over the length of the CTCP.

According to some applications, the I term is determined as an area between the temperature setpoint and the actual measured temperature (e.g., over the CTCP). As mentioned above a temperature measurement (e.g., of the cookware item) may be taken at distinct sampling points (e.g., as determined by Tₛ). For each measurement, an approximate area between the previous sampling time and the current sampling time, and between the temperature setpoint and the actual observed temperature is determined.

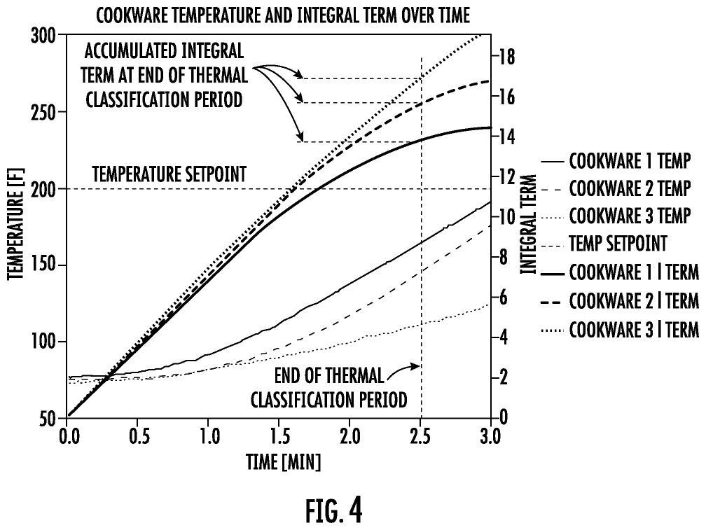

Accordingly, an accumulated I term over the CTCP may vary between different cookware items. For instance, varying properties of each individual cookware item may alter the thermal behavior of the cookware item, such as heating rate, heat retention, heat distribution, or the like. Referring to FIG. 4, measured temperatures of different cookware items (e.g., as also shown in FIG. 3) are provided along with accumulated I terms, in addition to the temperature setpoint and an exemplary end of the CTCP. As can be seen in FIG. 4, the longer a cookware item takes to reach the temperature setpoint, the greater the accumulated I term. For instance, as the error between the observed actual temperature and the temperature setpoint remains large, the I term will aggregate larger over the CTCP. As will be described below, cooking appliance 10 may observe and analyze the accumulated I term for specific cookware items and adjust one or more parameters of a cooking operation accordingly. Advantageously, cooking appliance 10 may utilize information already calculated within the PID controller to adjust parameters of a cooking operation, eliminating the need for extra computations, additional memory, or excessive combined algorithms to generate optimal cooking conditions for specific cookware items.

Now that the construction of cooking appliance 10 and a configuration of controller 50 according to exemplary embodiments have been presented, exemplary method 300 of operating a cooking appliance will be described. Although the discussion below refers to the exemplary method 300 of operating cooking appliance 10, one skilled in the art will appreciate that the exemplary method 300 is applicable to the operation of a variety of other cooking appliances. In exemplary embodiments, the various method steps as disclosed herein may be performed by controller 50 or a separate, dedicated controller. Additionally or alternatively, the various method steps may be performed in a different order, including additional steps or omitting certain steps according to specific embodiments.

At step 302, method 300 may include determining a temperature setpoint. In detail, a user may communicate with the cooking appliance (e.g., cooking appliance 10) a desire to initiate a cooking operation, a heating operation, or the like. For example, the cooking operation is a feedback controlled heating operation incorporating a PID algorithm to continually monitor the heating operation and perform adjustments as needed. The user may manually enter a temperature setpoint (e.g., a temperature at which the user desires to have the item cooked). Thus, using a user interface (e.g., control panel 22), the user may enter a specific cooking temperature as the temperature setpoint (e.g., 250° F., 300° F., 350° F., etc.). In additional or alternative embodiments, the user may provide information regarding a specific food item to be cooked (e.g., eggs, meat, vegetables, etc.). For instance, the cooking appliance may include features for selecting predetermined food items from the user interface or the cooking appliance may include a remote connectivity (e.g., wireless fidelity [WiFi], Bluetooth®, etc.), through which the user may select a food item (e.g., via a remote device). Further still, the user may input a particular recipe to be cooked on or in the cooking appliance. The temperature setpoint may be stored within the cooking appliance (e.g., within a controller or a memory therein).

At step 304, method 300 may include retrieving a default set of controller gain values of the feedback controlled heating operation. As described above, the feedback controlled heating operation may include a PID algorithm incorporating proportional, integral, and derivative feedback to properly adjust one or more parameters of the cooking operation. Accordingly, the default set of controller gains may include a proportional gain value (Kₚ), an integral gain value (Kᵢ), and a derivative gain value (K_{d}). For instance, the default gain value Kₚ may be set at 1, the default gain value Kᵢ may be set at 0.001, and the default gain value K_{d} may be set at 1. It should be noted that the values described herein are merely exemplary, and that any suitable values may be used for each of Kₚ, Kᵢ, and K_{d}. Further, the default gain values may remain constant throughout a predetermined time period (e.g., the CTCP).

At step 306, method 300 may include directing at least one heating element over a thermal classification length of time (e.g., CTCP). As mentioned above, once the default set of controller gain values are set, the heating element performing the feedback controlled heating operation may be activated to supply heat to the cookware item. According to at least some embodiments, the heating element may be directed at a predetermined power level. For instance, the heating element may be driven at a certain power percentage (e.g., 60%, 70%, 80%, etc.) over the CTCP. Additionally or alternatively, the heating element may be driven at a variable power rate over the CTCP. For instance, the feedback controlled heating operation may begin adjusting the power output of the heating element according, in part, to the current and accumulated error value (e.g., the difference between the temperature setpoint and the actual observed temperature of the cookware item).

At step 308, method 300 may include determining a thermal behavior of the cookware item after an expiration of the thermal classification length of time (e.g., CTCP). In detail, after the CTCP has ended (e.g., after the predetermined length of time has passed), the cooking appliance may analyze the accumulated integral (I) term over the course of the CTCP. In analyzing the accumulated I term, a general thermal behavior of the cookware item may be determined. As mentioned above, the thermal behavior may include such characteristics as heat transfer rate, heat retention, heat distribution (e.g., over an entirety of the cookware item or to a food item or other item provided in or on the cookware item), temperature rate of change, or the like. Accordingly, by analyzing the accumulated I term, the cooking appliance may determine a proper or specific set of parameters to be set for the cooking operation to most effectively perform the cooking operation.

As described above, the accumulated I term may be determined by or according to a difference between the temperature setpoint and the actual observed temperature over the CTCP. Accordingly, this may be defined as an area (e.g., within the CTCP as shown in FIG. 3) between the temperature setpoint and the actual observed temperature. For instance, when the I term is higher (e.g., relatively higher as compared against multiple accumulated I terms associated with different cookware items), the thermal behavior of the present cookware item may be deemed to have a low heat transfer rate (e.g., temperature rate of change), for example. Additional or alternative thermal attributes of the cookware item may be gleaned, determined, calculated, or otherwise determined, and the disclosure is not limited to the examples given herein.

Step 308 may include classifying, identifying, or otherwise storing the cookware item according to the determined thermal behavior. For instance, the cooking appliance (e.g., within the controller or a memory) may assign a unique identification to the cookware item and store the identification within the memory. Cooking appliance may include one or more tables (e.g., lookup tables) including cookware identifiers and associated thermal behavior attributes. Accordingly, previously used cookware items may be easily retrieved for future use. Additionally or alternatively, some cookware items may exhibit similar thermal behaviors as other different cookware items (e.g., a small cast iron pan and a large aluminum pot). Accordingly, in some instances, multiple cookware items may be stored under the same or similar identifiers.

At step 310, method 300 may include adjusting one or more parameters of the feedback controller heating operation in response to determining the thermal behavior of the cookware item. In detail, upon determining the thermal behavior of the cookware item currently in use, appropriate settings may be implemented for the cooking operation to ensure optimal response parameters or behaviors (e.g., rise time of temperature, overshoot, settling time, steady state error, etc.). For instance, the appliance (e.g., the controller) may consult a lookup table to retrieve corresponding parameters that match with the determined thermal behavior. The determined thermal behavior may include the accumulated I term. Thus, the lookup table may be represented as:

| Cookware Type | I Term | Kₚ | Kᵢ |
|---|---|---|---|
| 1 | 13.72 | 0.55 | 0.00085 |
| 2 | 14.86 | 0.65 | 0.00092 |
| 3 | 15.55 | 0.72 | 0.00100 |
| 4 | 16.71 | 0.86 | 0.00120 |

It should be noted that the table above is provided merely as an example, and the parameters to be adjusted may include additional or alternative features from Kₚ and Kᵢ. For instance, the adjustable parameters may include a total cook time, a power level of the heating element, a derivative gain term (e.g., K_{d}), or the like. Further, any suitable combination of parameters may be adjusted together, such as two or more of the gain values, a gain value and a cook time, etc. Additionally or alternatively, the determined thermal behavior or attributes of the cookware item may be used to adjust menu options for cooking operations, user interface displays or potential selections, appropriate burner selections or heating profiles, or the like.

The accumulated I term may be between certain predetermined or predefined values (e.g., as shown in the I Term column above). Thus, in some embodiments, the accumulated I term may be incorporated into an equation to determine appropriate parameters that may not be stored. For instance, if one or more controller gains are to be adjusted (e.g., Kᵢ, Kₚ, K_{d}), the values may be interpolated via one or more equations to determine more accurate values.

The adjusted parameters may thus be implemented into the feedback controlled heating operation. Accordingly, unique and tuned variables of the PID controller (e.g., controlling the feedback loop) may ensure a properly monitored and controlled cooking or heating operation for each specific and individual cookware item.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
at least one heating element to selectively supply heat to a cookware item;
a temperature sensor configured to selectively monitor a temperature of the cookware item; and
a controller operably connected with the at least one heating element and the temperature sensor, the controller configured to perform a feedback controlled heating operation, the feedback controlled heating operation comprising:
determining a temperature setpoint;
retrieving a default set of controller gain values of the feedback controlled heating operation, the set of controller gain values comprising a proportional gain value, an integral gain value, and a derivative gain value;
directing the at least one heating element over a thermal classification length of time;
determining a thermal behavior of the cookware item after an expiration of the thermal classification length of time; and
adjusting one or more parameters of the feedback controlled heating operation in response to determining the thermal behavior of the cookware item.

2. The cooking appliance of claim 1, wherein the one or more parameters of the feedback controlled heating operation comprise the proportional gain value, the integral gain value, and the derivative gain value.

3. The cooking appliance of claim 2, wherein determining the thermal behavior of the cookware item comprises:
determining an accumulated integral term based on a difference between a sensed temperature and the temperature setpoint over the thermal classification length of time.

4. The cooking appliance of claim 2, wherein adjusting the one or more parameters of the feedback controlled heating operation comprises adjusting each of the proportional gain value, the integral gain value, and the derivative gain value according to the accumulated integral term.

5. The cooking appliance of claim 4, wherein each of the proportional gain value, the integral gain value, and the derivative gain value is adjusted according to predetermined values provided in a lookup table, the predetermined values being associated with the accumulated integral term.

6. The cooking appliance of claim 4, wherein each of the proportional gain value, the integral gain value, and the derivative gain value is adjusted according to a predetermined equation based on the accumulated integral term.

7. The cooking appliance of claim 1, wherein the thermal classification length of time is defined between an initiation of the at least one heating element and 3 minutes.

8. The cooking appliance of claim 7, wherein the thermal classification length of time is defined between 1 minute and 2.5 minutes from the initiation of the at least one heating element.

9. The cooking appliance of claim 1, wherein the feedback controlled heating operation further comprises:
directing the at least one heating source according to the one or more adjusted parameters.

10. A method of operating a cooking appliance, the cooking appliance comprising one or more heating elements and a temperature sensor, the method comprising:
determining a temperature setpoint;
retrieving a default set of controller gain values of the feedback controlled heating operation, the set of controller gain values comprising a proportional gain value, an integral gain value, and a derivative gain value;
directing the at least one heating element over a thermal classification length of time;
determining a thermal behavior of the cookware item after an expiration of the thermal classification length of time; and
adjusting one or more parameters of the feedback controlled heating operation in response to determining the thermal behavior of the cookware item.

11. The method of claim 10, wherein the one or more parameters of the feedback controlled heating operation comprise the proportional gain value, the integral gain value, and the derivative gain value.

12. The method of claim 11, wherein determining the thermal behavior of the cookware item comprises:
determining an accumulated integral term based on a difference between a sensed temperature and the temperature setpoint over the thermal classification length of time.

13. The method of claim 11, wherein adjusting the one or more parameters of the feedback controlled heating operation comprises adjusting each of the proportional gain value, the integral gain value, and the derivative gain value according to the accumulated integral term.

14. The method of claim 13, wherein each of the proportional gain value, the integral gain value, and the derivative gain value is adjusted according to predetermined values provided in a lookup table, the predetermined values being associated with the accumulated integral term.

15. The method of claim 13, wherein each of the proportional gain value, the integral gain value, and the derivative gain value is adjusted according to a predetermined equation based on the accumulated integral term.

16. The method of claim 10, wherein the thermal classification length of time is defined between an initiation of the at least one heating element and 3 minutes.

17. The method of claim 16, wherein the thermal classification length of time is defined between 1 minute and 2.5 minutes from the initiation of the at least one heating element.

18. The method of claim 10, further comprising:
initiating a cooking operation by directing the at least one heating element according to the one or more adjusted parameters.
